(19) United States
(12) Patent Application Publication
(10) Pub. No.: US 2008/0044170 A1
(43) Pub. Date: Feb. 21, 2008

(54) Image Capturing System And Method Of Operating The Same

(76) Inventors: Choon Hwee Yap, Singapore (SG); Gregory V. Hofer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/464,828

(22) Filed: Aug. 16, 2006

(51) Int. Cl. G03B 7/093

(52) U.S. Cl. 396/52; 396/246

(57) ABSTRACT

An image capturing system capable of providing an optimal exposure setting and method of operating the same are disclosed. The image capturing system includes a CMOS image sensor having photosensitive cells; a lens module having a mechanical shutter; a memory having a program for exposure analysis and a program for detecting motion stored therein; and a controller having a processor. The processor is configured to execute the program for exposure analysis and the program for detecting motion. The exposure analysis includes determining the exposure time for capturing an image of a scene based on the brightness of the scene and comparing the exposure time with the closing time of the mechanical shutter. The controller is operable to set the image capturing system to either a “Global-Reset mode” or an “Electronic-Rolling-Shutter” (ERS) mode based on the output of the exposure analysis and motion detection. In the Global Reset mode, the mechanical shutter is utilized during sensor readout to shield the photosensitive cells from extraneous light. In the ERS mode, an electronic rolling shutter is utilized to perform image exposure and readout without closing the mechanical shutter at the end of an exposure period.

### FIELD OF THE INVENTION

The present invention relates generally to image capturing systems, particularly digital still cameras, and methods of operating the same.

### BACKGROUND

During image capture using a digital still camera, the brightness in the scene can range from very dark conditions (e.g. outdoor at night time) to extremely bright conditions (e.g. bright sun at mid-day). Under extreme lighting conditions, the camera may be unable to adequately expose the subject due to mechanical shutter and aperture limitations. For example, the captured image of a bright scene may appear overly bright with undesired saturation in the brightened objects in the scene.

In many digital still cameras with CCD sensors, a mechanical shutter is used to prevent extraneous exposure during the sensor's readout stage and to prevent unwanted image artifacts caused by extraneous light being integrated during sensor readout. These image artifacts may appear as dark and white banding across the image height. However, the use of a mechanical shutter also limits the camera's latitude for controlling exposure of bright scenes due to the finite closing time of the shutter. This closing time can be as much as 1/1000 sec in some cameras. As such, the camera's minimum exposure period is limited by the closing time that is mandatory for completely closing the mechanical shutter. In the event where the scene requires a shorter exposure period than this closing time, the scene is overly exposed. To capture bright scenes, the lens aperture could be stopped down to a smaller opening size to reduce the amount of light entering through the lens. However, lenses in many consumer digital cameras have limited aperture settings and opening sizes. Accordingly, if the scene is overly bright, the image may still be overly exposed even at the smallest aperture selection.

In order to provide exposure compensation for overly bright scenes, experienced photographers typically place a neutral density filter at the front of the lens to reduce the light entering into the lens system. Although this method of using neutral density filters may help to reduce overly exposed images, it requires the purchase of additional filters and the knowledge of how to use such filters. This option may not be popular to many consumers using point-and-shoot digital cameras.

There exists a need for an image capturing system that can overcome the limitations of conventional digital cameras with mechanical shutters and that can produce well exposed images without the need for additional equipments, such as neutral density filters.

### SUMMARY

The present invention provides an image capturing system capable of providing an optimal exposure setting and a method of operating the same. The image capturing system includes: a CMOS image sensor having photosensitive cells; a lens module having a mechanical shutter; a memory having a program for exposure analysis and a program for detecting motion in a scene stored therein; and a controller having a processor. The processor is configured to execute the program for exposure analysis and the program for detecting motion. The exposure analysis includes determining the exposure time for capturing an image of a scene based on the brightness of the scene and comparing the exposure time with the closing time of the mechanical shutter. The controller is operable to set the image capturing system to either a “Global-Reset mode” or an “Electronic-Rolling-Shutter” (ERS) mode based on the output of the exposure analysis and motion detection. In the Global Reset mode, the mechanical shutter is utilized during sensor readout to shield the photosensitive cells from extraneous light. In the ERS mode, an electronic rolling shutter is utilized to perform image exposure and readout without closing the mechanical shutter at the end of an exposure period.

The objects and advantages of the present invention will become apparent from the detailed description when read in conjunction with the drawings.

### BRIEF DESCRIPTION OF THE DRAWINGS

FIG. 1 is a block diagram showing the configuration of an image capturing system in accordance with an embodiment of the present invention.

FIG. 2 is a block diagram that illustrates an embodiment of a memory for the image capturing system of FIG. 1.

FIG. 3 shows a timing diagram of exposure control and readout when the image capturing system is set in a Global-Reset mode.

FIG. 4 shows a timing diagram of exposure control and readout when the image capturing system is set in an Electronic-Rolling-Shutter mode.

FIGS. 5 and 6 are flow charts illustrating a method of operating the image capturing system of FIG. 1 in accordance with an embodiment of the present invention.

FIGS. 7 and 8 are flow charts illustrating a method of operating the image capturing system of FIG. 1 in accordance with another embodiment of the present invention.

### DETAILED DESCRIPTION

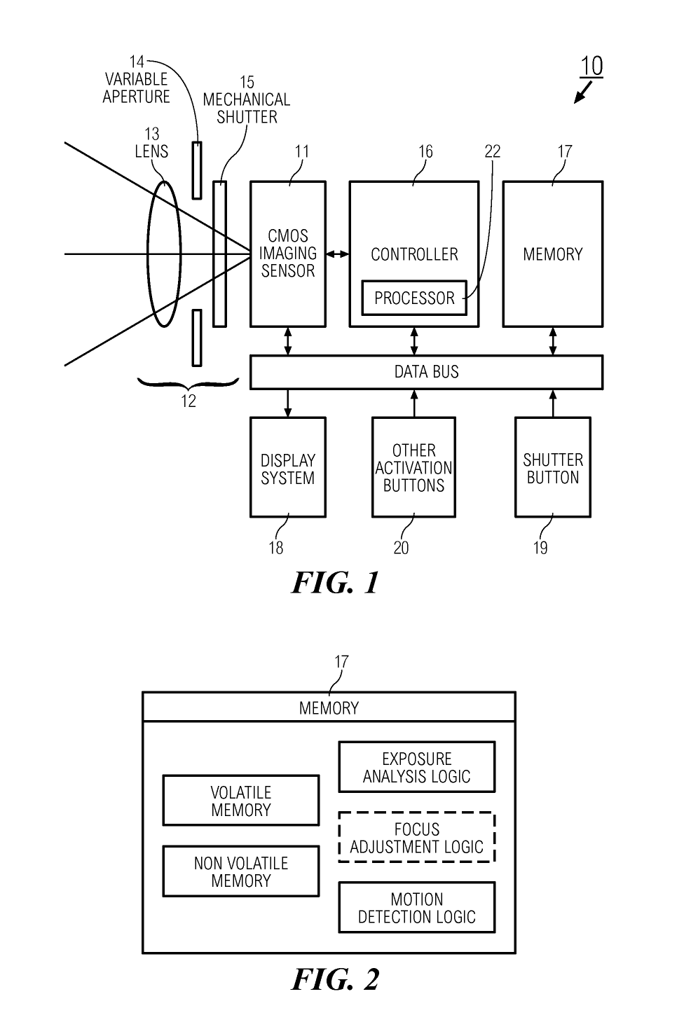

FIG. 1 is a block diagram showing the configuration of an image capturing system 10 according to an embodiment of the present invention. The image capturing system 10 includes a CMOS (complementary metal oxide semiconductor) image sensor 11 and a lens module 12 positioned in front of the CMOS image sensor 11 to focus a scene onto the image sensor. The CMOS image sensor 11 contains a plurality of photosensitive cells arranged in an array, each photosensitive cell corresponding to a pixel. This array contains a plurality of pixel rows arranged in a two-dimensional configuration. When reflected light from a scene hits the CMOS image sensor 11, electrical charges are accumulated in the photosensitive cells and a latent image is formed. After a period of integration or exposure, these charges are then read out and digitalized for further processing and storage.

The lens module 12 includes an optical lens 13, a variable aperture 14 and a mechanical shutter 15. The lens 13 may include multiple lens elements, and additional lens elements may be placed between the image sensor 11 and the mechanical shutter 15. The lens 13 may include a fixed focus lens or an auto focus lens. In addition, the lens module 12 may include a conventional zoom control mechanism configured so that different focal lengths are achievable. The variable aperture 14 is assembled in the lens module 12 to regulate the amount of light impinging onto the CMOS image sensor 11. The variable aperture 14 has two or more discrete opening positions or sizes. In bright light conditions, the aperture 14 may be switched to smaller sizes to reduce the amount of light, and hence, preventing over exposure of the captured image. In darker conditions, the aperture 14 may be switched to bigger sizes to permit more light through the lens 13 to achieve a brighter image. It should be understood by those skilled in the art that any number of openings and sizes are possible for the variable aperture 14. The mechanical shutter 15 is assembled in the lens module 12 and is configured to control light falling upon the image sensor 11. The mechanical shutter 15 is operable to open and to close according to a selected exposure setting, and when it is closed, it prevents the image sensor 11 from integrating extraneous light during charge readout at the end of an exposure period.

The image capturing system 10 further includes a controller 16, a memory 17, a display system 18, a shutter button 19 and other activation buttons or user interfaces 20. The controller 16 further includes a processor 22 for executing programs stored in the memory 17. The controller 16 communicates with other components through a data bus 21. In addition, the controller 16 interfaces with the image sensor to control exposure and to drive the operation of the image sensor. The display system 18 may include a color liquid crystal display (LCD), or another display system like cathode ray tube (CRT) television. The shutter button 19 has an intermediate position (depressed half-way) and an image capturing position (fully depressed). Other activation buttons or user interfaces 20 include activation buttons for selecting the operating modes or settings. Examples of such modes include aperture-priority shooting mode and shutter-priority shooting mode.

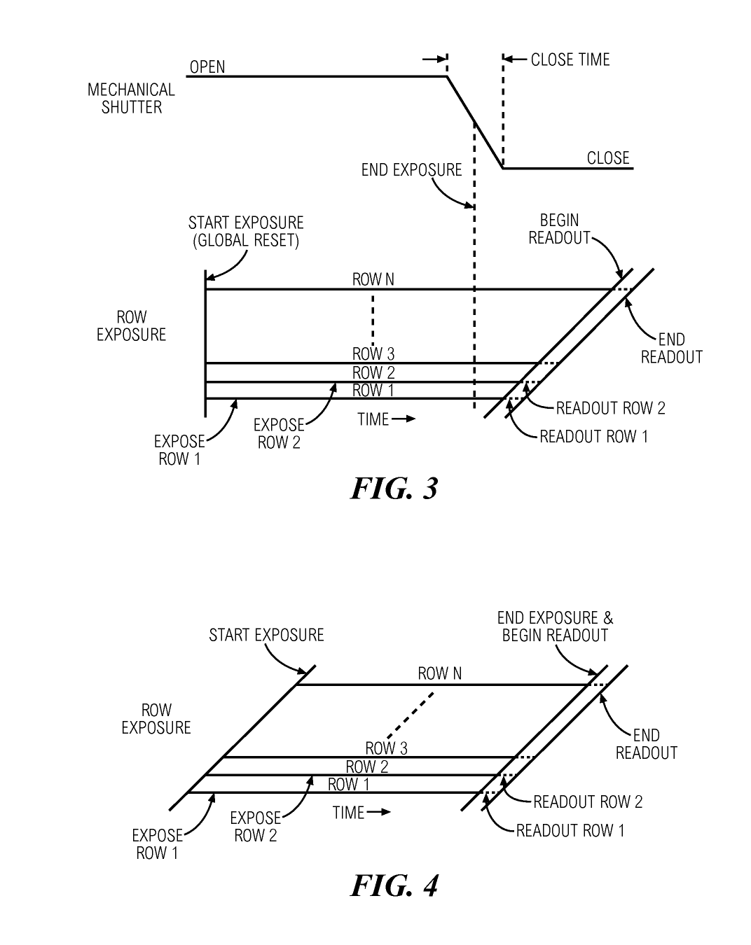

FIG. 2 is a block diagram that illustrates an embodiment of the memory 17 in the image capturing system 10. The memory 17 contains both a volatile memory and a non-volatile memory. The volatile memory may be a RAM type memory, e.g. DRAM, while the non-volatile memory may be an integrated on-board memory or a removable memory, such as a Secure Digital card. The non-volatile memory permanently stores programs for performing exposure analysis logic and motion detection logic. These programs may be transferred to the volatile memory during processing and are executed by the processor 22 in the controller 16 (FIG. 1). Other logics that constitute other operational functionalities may be stored in the memory 17.

The exposure analysis logic determines the optimal exposure parameters by performing scene statistic analysis. Scene statistic analysis may include calculating the brightness value or the histogram value on one or more low resolution image frames. The same frames may also be used for previewing a scene on the display system. The brightness value or histogram value obtained by the scene analysis would indicate how bright or dark the scene is being exposed by the image sensor 11. The exposure analysis logic uses the brightness value or histogram value to adjust the system parameters such that the captured image would have an optimal exposure. The system parameters may include the exposure time (or integration time) of the image sensor 11, the analog and digital gain settings in the image sensor 11, and the position or opening size of the variable aperture 14.

If auto-focusing is implemented, then a program for performing focus adjustment logic is also stored in the non-volatile memory. The focus adjustment logic provides steps for focus adjustment by moving the lens module 12 towards or away from the image sensor 11 to achieve optimal image sharpness.

The motion detection logic determines motion due to objects moving in a scene or movement of the image capturing system relative to the scene. To reduce the cost of manufacturing the image capturing system, motion is detected using the CMOS image sensor 11 itself. Various techniques for determining motion are readily available in the field. A typical technique involves comparing at least one pixel in a first frame with at least one pixel in a second frame to detect changes in the scene during the time interval while the two frames were captured by the image sensor. This process of comparing pixels may be repeated for successive pairs of frames to track movement of the image capturing system or movement of objects within the scene.

Comparison of pixels can be implemented in various ways. In one example, pixel-by-pixel difference in brightness value may be computed. In another example, pixel-by-pixel correlation may be performed. In this method, the pixels are compared in corresponding locations in two or more frames. By performing a search in which groups of pixels in the first frame are differentiated from the groups of pixels in the second frame, and computing the sum of absolute difference between these groups, a motion vector can be determined. Motion vector is indicative of magnitude and direction of the motion during the interval where the frames are captured by the image sensor.

For capturing images, the image capturing system 10 may operate in either Global Reset mode or Electronic-Rolling-Shutter (ERS) mode. In the Global Reset mode, the mechanical shutter 15 must be used together with the CMOS image sensor 11 for capturing images. In the ERS mode, image capture is accomplished without closing the mechanical shutter 15 at the end of an exposure period.

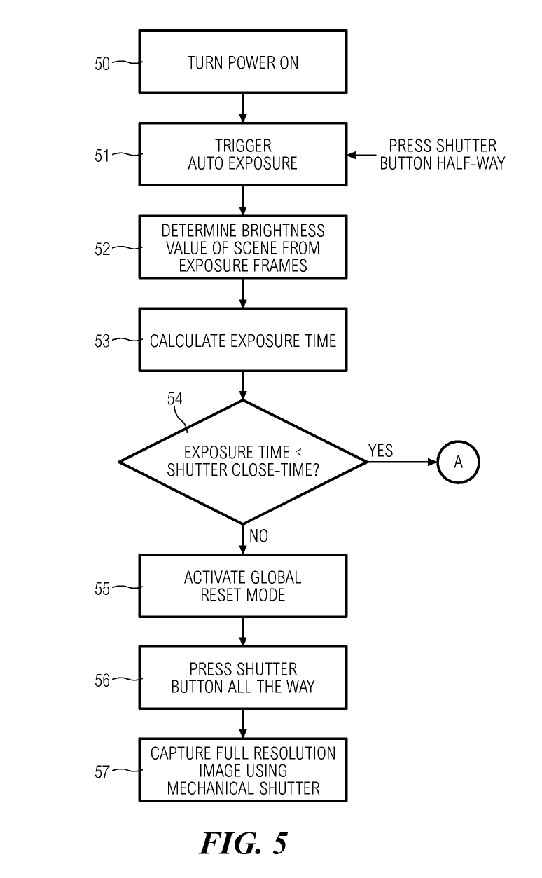

FIG. 3 shows a timing diagram of exposure control and readout when the image capturing system 10 is set in the Global Reset mode. A global reset signal is triggered to initiate the exposure of all lines for a captured image (indicated by “Start Exposure”). The photosensitive cells begin to integrate light to form a latent image. Near the end of the image sensor exposure time (predetermined earlier), the mechanical shutter 15 starts to close. The time to completely close the shutter is typically but not restricted to 1/1000 sec. When the mechanical shutter 15 has been closed sufficiently, exposure of a scene onto the image sensor 11 ends (indicated by “End Exposure”). The image sensor 11 continues in the integration mode but does not integrate any more light as the mechanical shutter 15 blocks any extraneous light from hitting the photosensitive cells. Readout of data begins with the first line being read out (dotted line referenced by “Readout row 1”). After the readout of row 1 is completed, the next row is readout (“Readout row 2”). This continues until the last row (Row N) to complete one full frame is readout. The readout delay between two adjacent rows is the interval of time to readout each line plus some additional overhead line blanking time. The readout delay is a function of sensor pixel clock frequency and the number of pixels in a row. The pixel clock determines how fast the row data are readout, and hence, determines the delay between the end of light integration for one row and the end of light integration for the next row. This delay can be reduced by using higher clock frequencies, and/or reducing the number of pixels readout in each row.

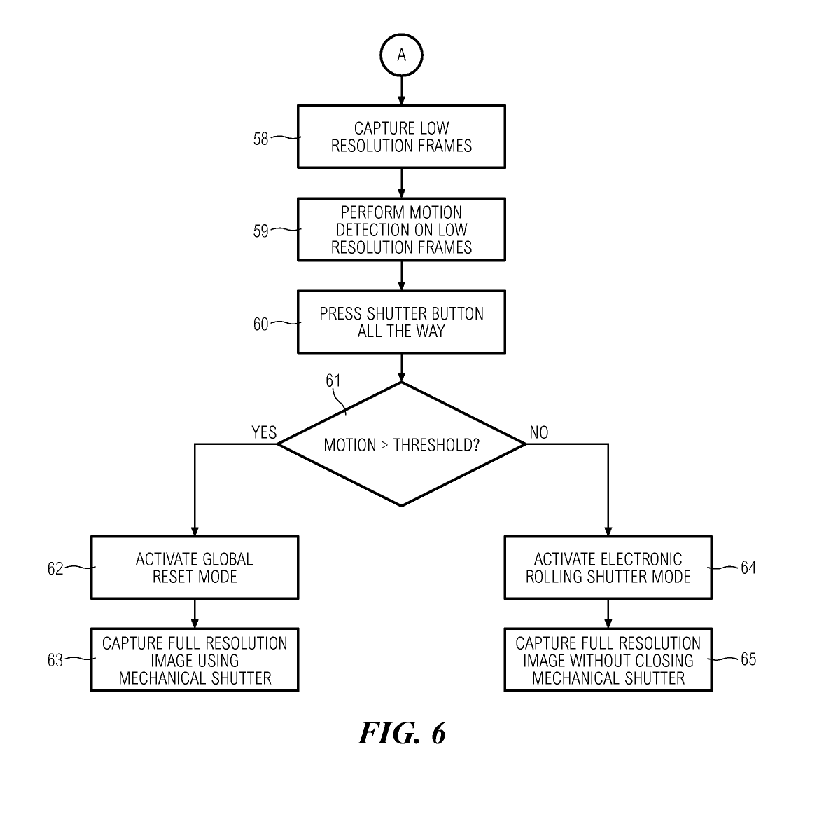

FIG. 4 shows the timing diagram of exposure control and readout when the image capturing system 10 is set in the ERS mode. In this mode, each line of image data is reset and readout at intervals that are shifted in time. As a result, an “electronic rolling shutter” is devised. Referring to FIG. 4, a reset signal is triggered at the first row (Row 1) to initiate exposure for this line. The photosensitive cells in this line begin to integrate light. After some delay (indicated by the dotted line in FIG. 4), another reset signal is triggered for the second row (Row 2) to initiate exposure of second line. This continues until the last row (Row N) to complete one full frame exposure and readout. The period between “Start Exposure” and “End Exposure” is the exposure time of each line. This period is the same for all lines in the image frame but it is skewed in time from row to row. The delay between the start of exposure for one row and the start of exposure for the next row is the same as the readout delay between two adjacent rows. This delay determines the slope of the exposure and the readout start/stop lines. The readout delay is also governed by the sensor pixel clock frequency and the number of pixels per line. The same method of reducing readout delay in Global Reset mode also applies to ERS mode. An advantage of this rolling exposure and readout scheme is that each line on the sensor frame records the scene with the same exposure without the use of a mechanical shutter. Therefore, the resulting exposure time can be much faster than that in the global reset mode because it is not limited by the closing time of a mechanical shutter. However, because each line records the scene at a different instant of time, image distortion arises when the image capturing system is moved with respect to the scene, or when objects in the scene move with respect to the camera.

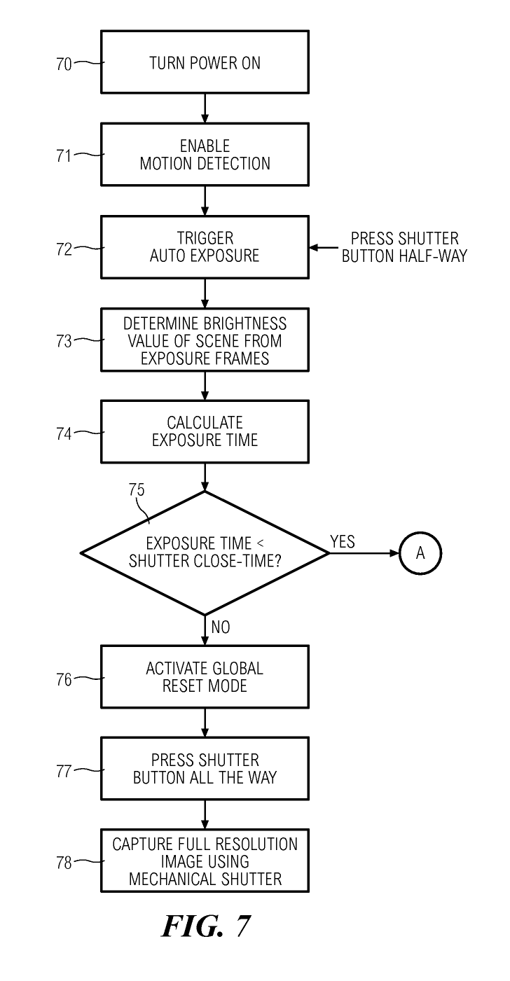

FIGS. 5 and 6 illustrate the operation of the image capturing system of FIG. 1 in accordance with an embodiment of the present invention. Referring to FIG. 5, at step 50, the power is turned on by the operator and the mechanical shutter is opened. At step 51, automatic exposure control is triggered by depressing the shutter-release button half-way. Automatic exposure control enables the image sensor to select the optimum exposure settings for a given scene lighting condition, without intervention from the operator. If automatic focusing is implemented, then it is also triggered when the shutter button is depressed half-way at step 51.

When automatic exposure control is triggered (step 51), a sample of preliminary exposure frames is captured for exposure analysis. Exposure analysis includes calculating the optimum ISO speed, shutter speed and aperture size using the sampled exposure frames. A sub-routine of this exposure analysis is determining the brightness value from the sampled exposure frames (step 52), and then calculating the optimum exposure time based on the brightness value (step 53). At step 54, the exposure time is compared with the shutter closing time. The shutter closing time is a fixed time and can be determined by empirical measurement or from its manufacturer. If the exposure time is greater than the shutter closing time, then the Global Reset mode is activated at step 55. The shutter-release button is fully depressed all the way at step 56. Subsequently, at step 57, a full resolution image is captured using the exposure settings determined from the exposure analysis. Because the image is captured according to the Global Reset mode, the mechanical shutter closes at the end of image exposure. On the other hand, if it is determined at step 54 that the exposure time is less than the shutter closing time, then the operation proceeds to A, which is the starting point of the flow chart shown in FIG. 6. The flow chart shown in FIG. 6 is applicable in situations where a scene to be captured is relatively bright and the exposure time is shorter than the shutter closing time.

Referring to FIG. 6, a series of low resolution image frames are captured at step 58. At step 59, motion detection is carried out using the low resolution frames. When motion detection is enabled, at least two successive frames are compared to detect the movement of the image capturing system relative to the scene or the subject movement. The process of comparing two successive frames may be repeated for successive pairs of frames. Motion detection continues until the operator depresses the shutter button all the way at step 60. The detected motion magnitude is compared with a threshold value at step 61. If the motion magnitude exceeds the threshold value then the Global-Reset mode is activated at step 62. This decision is made based on the assumption that an overly exposed image is more acceptable than an image that is distorted due to excessive motion. Subsequently, at step 63, a full resolution image is captured according to the Global-Reset mode, whereby the mechanical shutter closes at the end of image exposure. On the other hand, if it is determined at step 61 that the motion magnitude is less than the threshold value, then the ERS mode is activated at step 64. A full resolution image is then captured without closing the mechanical shutter according to the ERS mode at step 65.

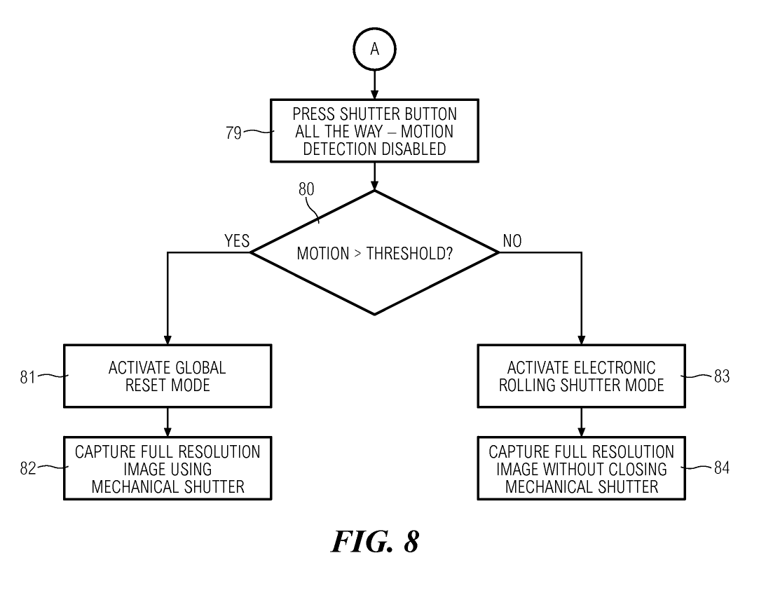

FIGS. 7 and 8 illustrate an operation method according to another embodiment. The operation method illustrated by FIGS. 7 and 8 is substantially the same as that described with reference to FIGS. 5 and 6, with the difference being as follows. Motion detection using live view, low resolution frames (step 71) is enabled prior to depressing the shutter button half-way (step 72). Motion detection continues until the shutter button is depressed all the way at step 79. At step 80, the detected motion magnitude is then compared with the threshold value.

### Applications of the Image Capturing System

The image capturing system 10 as described above may be embodied in a medium to high end camera with variable aperture settings. This type of camera may have different shooting mode options, such as “Aperture priority,” “Shutter priority,” “Portrait,” “Landscape,” and “Sports/Action” mode. When the camera is set to “Aperture priority” (i.e., AV) mode, the various aperture settings enable the photographer to achieve certain photographic artistry. With the operating method described with reference to FIGS. 5 and 6, it is possible to capture correctly exposed images of bright scenes using a large aperture setting when movement within a scene or camera movement is negligible. Furthermore, the mode selection by the user may be used to determine whether Global-Reset mode or ERS mode is the more suitable image capturing mode. For example, if the user selects “Portrait” or “Landscape” mode, the exposure analysis logic will determine that ERS mode is suitable because movement within a scene is likely to be low. On the other hand, if “Sports/Action” mode is selected, then the exposure analysis logic will determine that Global-Reset mode is the suitable mode.

As an option, a motion sensor may be installed in the camera to detect the camera movement (or shake) in order to prevent blur caused by such movement. Motion sensors, such as accelerometers or gyroscopes that measure camera pitch, yaw and roll rotation movements, may be utilized for this purpose.

The image capturing system 10 described with reference to FIG. 1 may be modified slightly so that it may be embodied in a low end camera. For this low end camera, the image capturing system would be the same as shown in FIG. 1 except that a fixed aperture is installed in place of a variable aperture in order to enable cost saving. This type of camera eliminates the need for a variable aperture and relies instead on the electronic rolling shutter for exposure control under bright light conditions regardless of motion.

While particular embodiments of the present invention has been disclosed in detail in the foregoing description and drawings, it will be understood by those skilled in the art that variations and modifications thereof can be made without departing from the scope of the invention as set forth in the following claims.

What is claimed is:

1. An image capturing system for capturing an image of a scene, said image capturing system comprising:
a CMOS image sensor having photosensitive cells;
a lens module having a mechanical shutter for controlling light falling upon the image sensor, said mechanical shutter having a shutter closing time;
a processor configured to execute exposure analysis and motion detection, wherein exposure analysis comprises:
(i) determining an exposure time for image capture, and
(ii) comparing the exposure time with the shutter closing time, and
wherein motion detection comprises detecting movement of the image capturing system relative to a scene or movement of a subject within the scene; and
a controller configured to set said image capturing system automatically to either a Global Reset mode or an Electronic-Rolling-Shutter (ERS) mode based on the result of comparing the exposure time with the shutter closing time and motion detection,
wherein, in the Global Reset mode, the mechanical shutter is utilized during sensor readout to shield the photosensitive cells from extraneous light, and in the ERS mode, an electronic rolling shutter is utilized to perform image exposure and readout without closing the mechanical shutter at the end of an exposure period.

2. The image capturing system of claim 1, wherein the image capturing system is set to ERS mode if the exposure time is less than the shutter closing time and the magnitude of the detected motion is less than a threshold amount.

3. The image capturing system of claim 2, wherein the image capturing system is set to Global Reset mode if:
(a) the exposure time is greater than the shutter closing time, or
(b) the exposure time is less than the shutter closing time, but the magnitude of the detected motion is greater than the threshold amount.

4. A digital still camera comprising:
a CMOS image sensor having photosensitive cells;
a lens module having a mechanical shutter for controlling light falling upon the image sensor, said mechanical shutter having a shutter closing time;
a shutter button;
a processor configured to execute exposure analysis and motion detection, wherein exposure analysis comprises:
(i) determining an exposure time for image capture, and
(ii) comparing the exposure time with the shutter closing time, and
wherein motion detection comprises detecting movement of the camera relative to a scene or movement of a subject within the scene; and
a controller configured to set the camera automatically to either a Global Reset mode or an Electronic-Rolling-Shutter (ERS) mode based on the result of comparing the exposure time with the shutter closing time and motion detection,
wherein, in the Global Reset mode, the mechanical shutter is utilized during sensor readout to shield the photosensitive cells from extraneous light, and in the ERS mode, an electronic rolling shutter is utilized to perform image exposure and readout without closing the mechanical shutter at the end of an exposure period.

5. The digital still camera of claim 4, wherein the lens module comprises a variable aperture.

6. The digital still camera of claim 4, wherein the lens module comprises a fixed aperture.

7. The digital still camera of claim 4 further comprising a motion detector for detecting camera movement.

8. The digital still camera of claim 4, wherein the shutter button is configured so that said exposure analysis is triggered when the shutter button is depressed part of the way, and motion detection is triggered prior to the shutter button being depressed all the way if it is determined from the exposure analysis that the exposure time is less than the shutter closing time.

9. The digital still camera of claim 4, wherein motion detection is triggered prior to the shutter button being depressed and motion detection continues until the shutter button is depressed all the way.

10. A method of operating an image capturing system that comprises a CMOS image sensor having photosensitive cells and a mechanical shutter with a shutter closing time, said image capturing system being operable in a Global Reset mode or an Electronic-Rolling-Shutter (ERS) mode, said method comprising:
capturing several preliminary image frames of a scene using the CMOS image sensor;
determining a brightness value based on the preliminary image frames;
calculating an exposure time based on the brightness value;
comparing the exposure time with the shutter closing time;
detecting motion due to movement of the image capturing system relative to the scene or movement of a subject within the scene;
automatically setting the image capturing system to either Global Reset mode or ERS mode based on the result of comparing the exposure time with the shutter closing time and the magnitude of the detected motion; and
capturing a full resolution image after the image capturing system has been set to either the Global Reset mode or the ERS mode,
wherein, in the Global Reset mode, the mechanical shutter is utilized during sensor readout to shield the photosensitive cells from extraneous light, and in the ERS mode, an electronic rolling shutter is utilized to perform image exposure and readout without closing the mechanical shutter at the end of an exposure period.

11. The method of claim 10, wherein the image capturing system is set to ERS mode if the exposure time is less than the shutter closing time and the magnitude of the detected motion is less than a threshold amount.

12. The method of claim 11, wherein the image capturing system is set to Global Reset mode if:
(a) the exposure time is greater than the shutter closing time, or
(b) the exposure time is less than the shutter closing time, but the magnitude of the detected motion is greater than a threshold amount.
